(19) United States
(12) Patent Application Publication
(10) Pub. No.: US 2025/0370097 A1
(43) Pub. Date: Dec. 4, 2025

(54) Method for Detecting Precipitation Deposits on a Radome and For Open-Loop and/or Closed-Loop Control of at Least One Heating Element of the Radome, Computing Device, Computer-Readable (Storage) Medium and Temperature-Controllable Radar Sensor System

(71) Applicant: Bayerische Motoren Werke Aktiengesellschaft, Muenchen (DE)

(72) Inventors: Juan Carlos FUENTES MICHEL, Muenchen (DE); Jonathan ROTH, Muenchen (DE); Karsten THURN, Pfaffenhofen (DE)

(21) Appl. No.: 18/876,536

(22) PCT Filed: Jun. 13, 2023
(86) PCT No.: PCT/EP2023/065715

§ 371 Date: Dec. 18, 2024

(30) Foreign Application Priority Data
Jun. 20, 2022 (DE) 10 2022 115 241.3

(51) Int. Cl. G01S 7/40; G01S 13/88

(52) U.S. Cl. CPC G01S 7/4043; G01S 13/88

(57) ABSTRACT

A method detects precipitation deposits on a radome of a radar sensor of a vehicle and open-loop and/or closed-loop controls at least one heating clement of the radome.

### BACKGROUND AND SUMMARY

The present invention relates to a method for the early detection of precipitation deposits on a radome of a radar sensor of a vehicle and for the open-loop and/or closed-loop control of at least one heating element of the radome. Furthermore, the present invention relates to a computing device for carrying out such a method and to a computer-readable (storage) medium. Finally, the present invention relates to a temperature-controllable radar sensor system for a vehicle.

Vehicles with modern assistance systems often comprise radar sensors, which are used to detect objects in the surroundings of the vehicle, for example. In particular, such radar sensors are used together with longitudinal control systems. To protect these radar sensors from environmental influences such as the effects of weather, for example, the radar sensors are installed behind so-called radomes. In cold weather conditions, for example, it can happen that precipitation in the form of ice, snow or the like is deposited on the radome of the radar sensor. Such a precipitation deposit can have a disadvantageous effect on the functioning and performance of the radar sensor. In particular, such a precipitation deposit can also have this effect on the availability of assistance systems of the vehicle.

To prevent a deposit of precipitation, the radome can be equipped with a heating element, for example. The heating element, for example in the form of a heating wire, can be arranged inside the radome. The heating element can be activated by means of a heating signal. Consequently, the temperature of the radome can be controlled. The precipitation deposit in the form of ice, snow and/or the like can therefore be removed.

In order to not heat the radome permanently, closed-loop control of the heating element can take place, for example, as a function of the outside temperature. Moreover, further characteristic variables are known, as a function of which the heating element can be activated.

Document DE 10 2017 221 589 A1, for example, discloses a system for a radome of a radar for a motor vehicle, wherein the heating system comprises a heating element for heating the radome, and an open-loop control unit, connected to the heating element, for activating the heating element. The open-loop control unit is designed to accept or determine a variable that is characteristic of an outside temperature, to accept or determine a variable related to a melting point of precipitation deposits on an outer surface of a radome. To determine at least one temperature threshold value as a function of the variable related to the melting point, and to activate the heating element as a function of a threshold value comparison of the outside temperature with the temperature threshold value.

The object of the present invention is to identify a solution as to how the detection of a precipitation deposit on a radome of a radar sensor of a vehicle can be improved. A further object of the present invention is to identify a solution as to how the open-loop and/or closed-loop control of radome heating can be improved.

This object is achieved according to the invention by a method, by a computing device, by a computer-readable (storage) medium and by a temperature-controllable radar sensor system for a vehicle having the features according to the independent claims. Advantageous developments of the present invention are specified in the dependent claims.

A method according to the invention for the early detection of precipitation deposits on a radome of a radar sensor of a vehicle and for the open-loop and/or closed-loop control of at least one heating element of the radome comprises emitting a transmission signal by means of at least one transmission antenna of the radar sensor. The method additionally comprises capturing a received signal by means of at least two receiving antennas of the radar sensor, wherein the received signal describes the transmission signal reflected by an object in the surroundings of the vehicle. In addition, the method comprises determining an attenuation parameter which describes an attenuation of the received signal, caused by precipitation deposits. Finally, the method comprises outputting a heating signal for the open-loop and/or closed-loop control of the at least one heating element of the radome, wherein the heating signal is output as a function of the attenuation parameter. An early precipitation deposit can be detected in at least one heating region of the radome on the basis of the attenuation parameter, wherein the at least one heating region describes a subregion of the radome. To detect the early precipitation deposit in the heating region, the at least one heating region of the radome can be associated with a subset of antennas, wherein the subset of antennas describes any subset of a set comprising the at least one transmission antenna and the at least two receiving antennas.

The method according to the invention is therefore used for the early detection of a precipitation deposit on the radome of the radar sensor of the vehicle. The method according to the invention is additionally used for the open-loop and/or closed-loop control of at least one heating element of the radome as a result of the early detection of precipitation deposits on the radome. The method can be performed, for example, on a computing device of the radar sensor and/or on a computing device of the vehicle. The computing device can be formed as an electronic control device, for example, which comprises one or more programmable processors.

Initially, therefore, the transmission signal is emitted by means of the at least one transmission antenna of the radar sensor. Today, modern radar sensors are mostly so-called multi-channel systems with a plurality of transmission antennas. The basic principle of the method according to the invention requires a transmission antenna. If, however, the radar sensor has multiple transmission antennas, meaning for example 2 transmission antennas, 4 transmission antennas, 8 transmission antennas, 16 transmission antennas or the like, the method can be refined and optimized for the early detection of precipitation deposits. Hereinafter, however, the method will be described in general terms as having at least one transmission antenna, in the full knowledge that this can also mean 3, 4, 5, 6 etc transmission antennas.

The transmission signal emitted by means of the at least one transmission antenna can be reflected by an object in the surroundings of the vehicle. In particular, the emitted transmission signal can be reflected back to the radar sensor. Consequently, the reflected transmission signal can be captured by means of the at least two receiving antennas of the radar sensor. The transmission signal which is reflected back by the object in the surroundings of the vehicle, and is received by the at least two receiving antennas, is also referred to as a received signal.

Modern radar sensors in the automotive sector are mostly so-called frequency-modulated continuous-wave radars (FMCW radar). The object in the surroundings can be described from a differential signal, which describes the frequency difference between transmission signal and received signal. Typically, a distance and an (azimuth) angle can be assigned to the object. The more receiving antennas the radar sensor has, the more accurately can the (azimuth) angle be determined. Today, therefore, modern radar sensors mostly comprise 4 receiving antennas, 8 receiving antennas, 16 receiving antennas, 32 receiving antennas or the like. The method according to the invention requires at least two receiving antennas. In general terms, therefore, reference is made to at least two receiving antennas, in the full knowledge that this can also mean 3, 4, 5, 6 etc receiving antennas.

The received signal can be captured and separately evaluated using each of the at least two receiving antennas. It is thereby possible for a capacity, a phase and/or an amplitude of the received signal to be determined for each of the at least two receiving antennas and to be compared with one another. In other words, the received signal captured by means of a first receiving antenna can therefore be correlated with the received signal captured by means of a second receiving antenna. In particular, the phase, amplitude and/or frequency can be correlated with one another. For example, the amplitude or capacity of the received signal can deviate between the receiving antennas if one of the at least two receiving antennas has a precipitation deposit on the radome and within the visual field thereof.

As a result, an attenuation parameter can be determined, which describes an attenuation of the received signal, caused by precipitation deposits. In particular, the attenuation parameter can be vector-valued. The attenuation parameter can thus specify an attenuation value for each of the at least two receiving antennas and/or for each of the at least one transmission antenna, which attenuation value describes an attenuation of the received signal, caused by precipitation, for each of the at least two receiving antennas or for each of the at least one transmission antenna.

Following this, a heating signal for the open-loop and/or closed-loop control of the at least one heating element of the radome can be output. The heating signal can be output as a function of the attenuation parameter. In addition, the heating signal can also describe the heating region of the radome. As a result, the at least one heating element can optionally be activated individually for the respective antenna which has a precipitation deposit within its visual field.

Existing methods for the detection of precipitation deposits on a radome can, under certain circumstances, likewise determine an attenuation parameter. However, in the method according to the invention, a deposit of precipitation is already detected at an early stage. For example, a precipitation deposit on the radome is already detected when only one of the antennas of the radar sensor or one visual field is affected by the precipitation deposit. Existing methods are not as sensitive and often require a certain minimum attenuation. In particular, with a large number of receiving and/or transmission antennas, the total attenuation is lower if only one of the antennas is influenced by the precipitation deposit. Consequently, with the method according to the invention, the more receiving and/or transmission antennas the radar sensor has, the higher the sensitivity of the detection of precipitation deposits.

In summary, therefore, by means of the method according to the invention, it can be detected individually for each antenna whether precipitation is being deposited in the visual field thereof. The respective antenna can be associated with a heating region which comprises the visual range of the antenna, for example. If a deposit is detected by means of the method, the heating region or the heating element, which is designed to control the temperature of the corresponding heating region, can thus be activated accordingly.

The temperature control of the radome is often linked to considerable heating capacity. For example, the heating capacity can be 100 watts or more. In order to not waste any unnecessary energy and—in the case of battery-electric vehicles-range, the temperature control of the radome can be made more sustainable and more efficient by means of the method according to the invention. Through the early detection of the precipitation deposit, preconditioning of the heating element of the radome is also possible. As a result, the time of activation for heating a radome can be selected in an optimum manner. In addition, a localized heating strategy is possible. As a result, the heating capacity can be reduced further. Therefore, in the case of battery-operated vehicles, the range can be increased again.

A further advantageous embodiment of the method according to the invention envisions that the heating signal additionally describes the at least one heating region of the radome within which the early precipitation deposit is detected. If the radome of the radar sensor has multiple regions with mutually independent heating elements, for example, individual areas of the radome or subregions of the radome can be temperature-controlled separately. In such a case, it can be helpful if the heating signal activates or closed-loop controls precisely that subregion or heating region of the radome within which the precipitation deposit is detected. Therefore, the temperature of the radome can be controlled in a specific manner and while saving unnecessary heating capacity. Such a saving of energy can be an advantage in particular with battery-electric vehicles.

It is additionally advantageous if at least one receiving-antenna attenuation parameter is determined for one of the at least two receiving antennas when the attenuation parameter is determined, wherein the receiving-antenna attenuation parameter describes the attenuation at one of the at least two receiving antennas, caused by precipitation deposits. In other words, it can therefore be advantageous if a value for the attenuation of one of the at least two receiving antennas is determined.

For the early detection of precipitation deposits on the radome of the radar sensor and for the open-loop and/or closed-loop control of the at least one heating element of the radome, it is a priori not necessary if explicit values for the attenuation for the receiving antennas are determined. As a result of the determination of at least one receiving-antenna attenuation parameter, a more sensitive and thus earlier detection of precipitation deposits can be made possible. In particular, early detection of precipitation deposits can be captured in a visual range of one of the at least two receiving antennas. Therefore, by means of the method, a sensitive (virtual) sensor can be provided for the detection of precipitation deposits on the radome. In addition, a heating strategy or the temperature control of the radome can be improved.

A further advantageous embodiment, which functions in the same way as the case just described, envisions that at least one transmission-antenna attenuation parameter is determined for one of the at least one transmission antenna when the attenuation parameter is determined, wherein the transmission-antenna attenuation parameter describes the attenuation at one of the at least one transmission antenna, caused by precipitation deposits. In other words, a deposit in a visual field or a transmission range of the at least one transmission antenna, caused by precipitation, can therefore be detected by means of a transmission-antenna attenuation parameter which describes a value for the attenuation of the transmission signal emitted by means of one of the transmission antennas. By means of the heating signal, therefore, the temperature of the transmission range or the visual range (as long as the respective transmission antenna is associated with a corresponding heating region) of the at least one transmission antenna can be controlled in a targeted manner. Further advantages apply in the same way to the embodiment just explained, which comprises determining a receiving-antenna attenuation parameter.

A further advantageous embodiment envisions that the determination of the attenuation parameter comprises a radar target comparison in which antenna-specific radar target signals, which are determined for each of the at least two receiving antennas by means of the received signal and describe one (and the same) object in the surroundings of the vehicle, are compared with one another. In other words, it can therefore be helpful if initially a radar target is detected by means of the received signal of each one of the at least two receiving antennas. The object is preferably situated at least 10 meters away from the radar sensor. The object is preferably situated in an azimuth angle range of at most ±20° in front of the radar sensor.

For example, it is possible that a target 20 meters away is detected by means of each of the at least two receiving antennas or the received signal thereof. A signal capacity, an amplitude, a phase or the like can be assigned to each of the targets or objects detected in this way. The attenuation parameter can therefore be determined by a comparison across (receiving) antennas. For example, if the received capacity by means of the first of the at least two receiving antennas is lower than the capacity of the second receiving antenna of the at least two receiving antennas, this can indicate a deposit in the visual field of the first receiving antenna, caused by precipitation. The attenuation parameter can be determined from such a difference in capacity. The amplitude of the radar target, the phase of the radar target and/or the frequency can be compared for the radar target comparison. In other words, it is advantageous if the radar target comparison comprises a comparison of the amplitude, phase and/or frequency of the antenna-specific radar target signals. If the radar target comparison comprises a comparison of the phase, it can be advantageous if the at least two receiving antennas comprise 3, 4, . . . , 8, . . . , 16 or more receiving antennas.

In addition, it can be advantageous if a temporal and/or spatial plausibility check is carried out in the radar target comparison. In the temporal plausibility check, the radar target comparison can be repeated during a further measurement cycle of the radar sensor. In the spatial plausibility check, the radar target comparison can be repeated with at least one further antenna-specific radar target signal which describes a further object in the surroundings of the vehicle. In other words, a temporal and/or spatial plausibility check gives a more reliable determination of the attenuation parameter. It is also conceivable for the attenuation parameter to be averaged over time and/or space.

A further aspect of the invention relates to a computing device for the early detection of precipitation deposits on a radome of a radar sensor of a vehicle and for the open-loop and/or closed-loop control of at least one heating element of the radome, wherein the computing device is designed to activate the radar sensor to emit a transmission signal by means of at least one transmission antenna of the radar sensor. Moreover, the computing device is designed to receive a received signal captured by means of at least two receiving antennas of the radar sensor, wherein the received signal describes the transmission signal reflected by an object in the surroundings of the vehicle. In addition, the computing device is designed to determine an attenuation parameter which describes an attenuation of the received signal, caused by precipitation deposits. Finally, the computing device is also designed to activate and/or closed-loop control the at least one heating element of the radome by means of a heating signal as a function of the attenuation parameter. The computing device is further designed to detect an early precipitation deposit in the at least one heating region of the radome on the basis of the attenuation parameter, wherein the at least one heating region describes a subregion of the radome, and, for this purpose, to associate the at least one heating region of the radome with a subset of antennas, wherein the subset of antennas describes any subset of a set comprising the at least one transmission antenna and the at least two receiving antennas.

The computing device can be formed as an electronic control unit, for example, which comprises one or more programmable processors. The computing device can additionally be designed to perform the advantageous configurations of the method according to the invention.

A computer-readable (storage) medium according to the invention comprises commands which, during performance by a computing device, prompt the latter to perform a method according to the invention and the advantageous configurations thereof.

A temperature-controllable radar sensor system according to the invention for a vehicle comprises a radar sensor which is designed to emit a transmission signal by means of at least one transmission antenna and to capture a received signal by means of at least two receiving antennas. The temperature-controllable radar sensor system additionally comprises a radome which in turn comprises at least one heating region, the temperature of which can be controlled by means of at least one heating element and which is arranged at least partially within a visual field of a subset of antennas, wherein the subset of antennas describes any subset of a set comprising the at least one transmission antenna and the at least two receiving antennas. The temperature-controllable radar sensor system further comprises at least one heating element which is designed to control the temperature of at least one heating region of the radome as a result of a heating signal output by a computing device. Finally, the temperature-controllable radar sensor system comprises a computing device for the early detection of precipitation deposits on the radome of the radar sensor of the vehicle and for the open-loop and/or closed-loop control of the at least one heating element of the radome.

A further aspect of the invention relates to a computer program, comprising commands which, during performance of the program by a computing device, prompts the latter to perform a method according to the invention and the advantageous configurations thereof. Furthermore, the invention relates to a vehicle comprising a temperature-controllable radar sensor system. The vehicle can be formed as a passenger motor vehicle, in particular.

The preferred embodiments, and the advantages thereof, presented in relation to the method according to the invention apply correspondingly to the computing device according to the invention, to the computer-readable (storage) medium according to the invention and to the temperature-controllable radar sensor system according to the invention. Furthermore, the preferred embodiments, and the advantages thereof, presented in relation to the method according to the invention also apply to the computer program according to the invention and to the vehicle according to the invention.

Further features of the invention emerge from the claims, the figures and the description of the figures. The features and combinations of features mentioned in the description above, and the features and combinations of features mentioned in the description of the figures below and/or shown in the figures alone can be used not only in the respectively specified combination, but also in other combinations or in isolation without departing from the scope of the invention.

The invention will now be explained in more detail on the basis of preferred exemplary embodiments and with reference to the accompanying drawings.

### BRIEF DESCRIPTION OF THE DRAWINGS

FIG. 1 shows a schematic depiction of a temperature-controllable radar sensor system, wherein an attenuation of the received signal occurs on account of a precipitation deposit,

FIG. 2 shows a schematic depiction of a temperature-controllable radar sensor system the same as FIG. 1, wherein the temperature-controllable radar sensor system has two heating elements,

FIG. 3 shows a schematic depiction of a temperature-controllable radar sensor system the same as FIG. 1, wherein an attenuation of the transmission signal occurs on account of a precipitation deposit,

FIG. 4 shows a schematic depiction of a temperature-controllable radar sensor system the same as FIG. 1, wherein the temperature-controllable radar sensor system has three heating elements and an attenuation of the received signal occurs within multiple heating regions on account of two precipitation deposits.

### DETAILED DESCRIPTION OF THE DRAWINGS

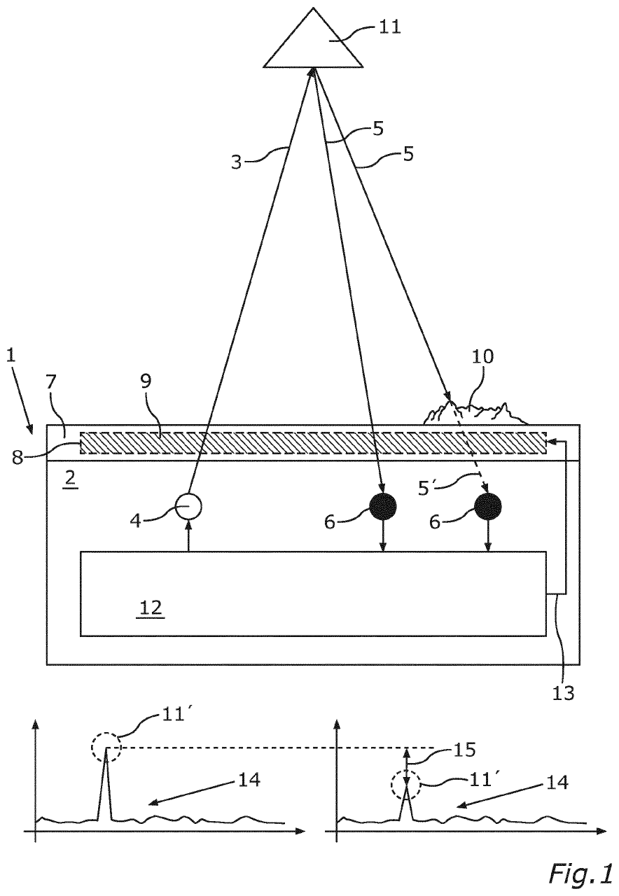

FIG. 1 shows a schematic depiction of a temperature-controllable radar sensor system 1 for a vehicle. The temperature-controllable radar sensor system 1 comprises a radar sensor 2, which is designed to emit a transmission signal 3 by means of at least one transmission antenna 4 and to capture a received signal 5 by means of at least two receiving antennas 6. The temperature-controllable radar sensor system 1 further comprises a radome 7, which in turn comprises at least one heating region 8. The heating region 8 can be arranged within a visual field of a subset of antennas. The temperature of the at least one heating region 8 can be controlled by means of at least one heating element 9, depicted in a hatched manner here. The at least one heating element 9 can be formed as a heating wire or as a heating foil, for example.

A precipitation deposit 10 is situated on the radome 7 of the radar sensor 2. Such a precipitation deposit 10 can lead to the transmission signal 4 reflected by an object 11 in the surroundings, that is to say the received signal 5, being received in an attenuated form. Such an attenuated received signal 5′ is depicted by the dashed arrow 5′ in FIG. 1. The attenuated received signal 5′ can be captured by one of the at least two receiving antennas 6. The received signal 5 captured by the at least two receiving antennas 6, or the attenuated received signal 5′, can then be processed by a computing device 12.

The temperature-controllable radar sensor system 1 finally comprises such a computing device 12. The computing device 12 is used for the early detection of precipitation deposits on the radome 7 of the radar sensor 2. The computing device 12 is additionally used for the open-loop and/or closed-loop control of the at least one heating element 9 of the radome 2. For this purpose, the computing device 12 can output a heating signal 13 to the at least one heating element 9.

FIG. 1 also shows the radar target signals 14 of the at least two receiving antennas 6. In other words, FIG. 1 therefore also shows the radar target signals 14 for each of the receiving antennas of the at least two receiving antennas 6 from FIG. 1. The right-hand receiving antenna of the at least two receiving antennas 6 can detect a lower capacity of the radar target signal 14 on account of the precipitation deposit 10. The object 11 can be described by the peak 11′ within the radar target signals 14. An attenuation parameter, for example, can be determined on the basis of the difference 15 which arises from the (amplitude) difference between the two peaks 11 and 11′ of the radar target signals 14. The heating signal 13 can be output to the at least one heating element 9 as a function of the attenuation parameter.

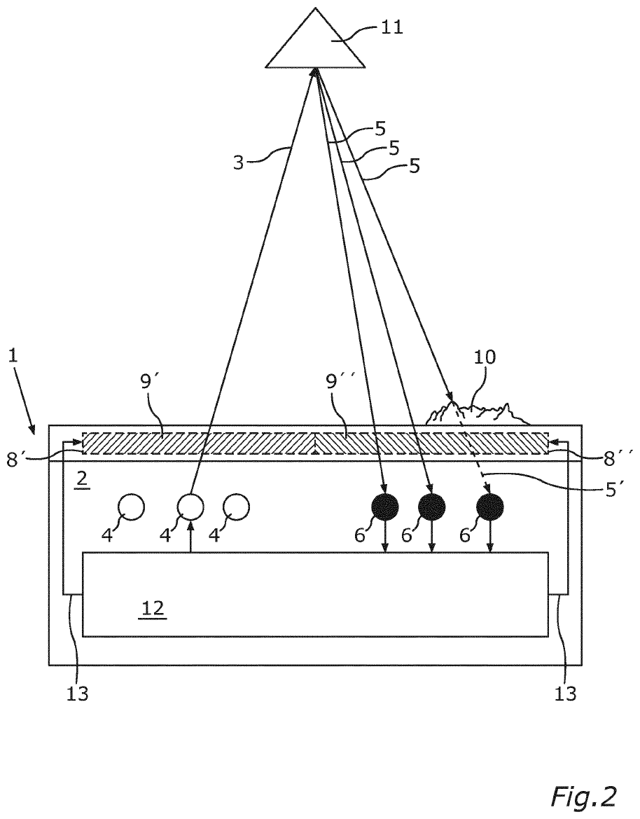

FIG. 2 shows a schematic depiction of a temperature-controllable radar sensor system 1 the same as FIG. 1. In FIG. 2, the temperature-controllable radar sensor system 1, or the radome 7, has two heating regions 8′ and 8″. The two heating regions 8′ and 8″ thus form the at least one heating region 8 of the temperature-controllable radar sensor system 1.

Moreover, the temperature-controllable radar sensor system also has two heating elements 9′ and 9″. In other words, the at least one heating element 9 is therefore formed by the two heating elements 9′ and 9″. The two heating elements 9′ and 9″ can be activated independently of one another by the computing device 12 by means of the heating signal 13. The precipitation deposit 10 can be located precisely and assigned to one of the heating regions 8′ or 8″. In FIG. 2, the precipitation deposit 10 is situated within the heating region 8″. The at least two receiving antennas 6, depicted as three receiving antennas here, can be associated with the heating region 8″, since the visual field of the at least two receiving antennas 6 comprises the heating region 8″ or at least overlaps with the heating region 8″. As a result, the attenuation caused by precipitation can be assigned to the heating region 8″ on account of the precipitation deposit 10. Consequently, the heating element 9″ can be activated by the computing device 12 by means of the heating signal 13.

The heating signal 13 can describe the at least one heating region 8, so that the temperature of the heating region 8′ is not controlled by means of the heating element 9′ even if the heating signal 13 of each of the at least one heating element 9 is output.

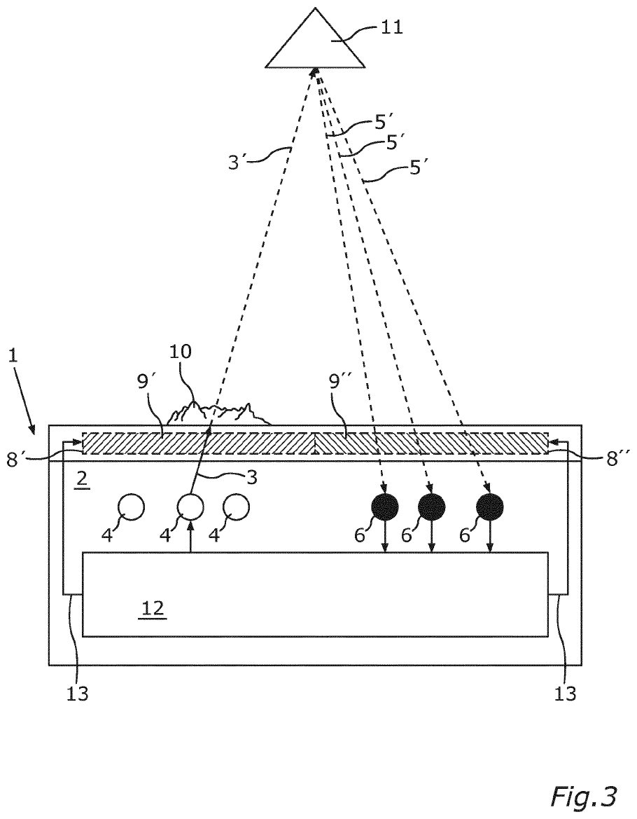

FIG. 3 shows a schematic depiction of a temperature-controllable radar sensor system 1 according to FIG. 2, wherein the precipitation deposit 10 already leads to an attenuation of the transmission signal 3. The attenuated transmission signal is depicted by the dashed arrow 3′. The attenuated transmission signal, which is reflected by the object 11, leads to the received signal 5 also being fully attenuated. The attenuated received signal 5′ is depicted by the dashed arrows 5′. With the method according to the invention, it can also be established if the precipitation deposit 10 leads to an attenuation of the transmission signal 3 from one of the at least one transmission antenna 4. It is advantageous if different coding or multiplexing methods are used for this.

Coding and/or multiplexing methods, such as for example the so-called time-division multiplexing method in which the transmission antennas of the at least one transmission antenna 4 transmit in a temporally offset manner, make it possible to assign a precipitation deposit 10 in the visual range of one of the at least one transmission antenna 4, depicted by three transmission antennas here, to an explicit transmission antenna. In FIG. 2, the time-division multiplexing method is depicted by the fact that the middle one of the at least one transmission antenna 4 emits a transmission signal 3. At a later point in time, it is therefore conceivable that one of the other two transmission antennas of the at least one transmission antenna 4 emits the transmission signal 3.

In FIG. 3, an identically attenuated received signal 5′ is received by the at least two receiving antennas, depicted by three receiving antennas here. On account of the fact that all of the at least two receiving antennas 6 receive an attenuated received signal 5′, this can indicate a precipitation deposit 10 within the heating region 8′. As a function of an attenuation parameter determined in this way, the heating element 9′, which is designed to control the temperature of the heating region 8′, can be activated and/or closed-loop controlled by the computing device 12 by means of the heating signal 13, which describes the corresponding heating region 8′.

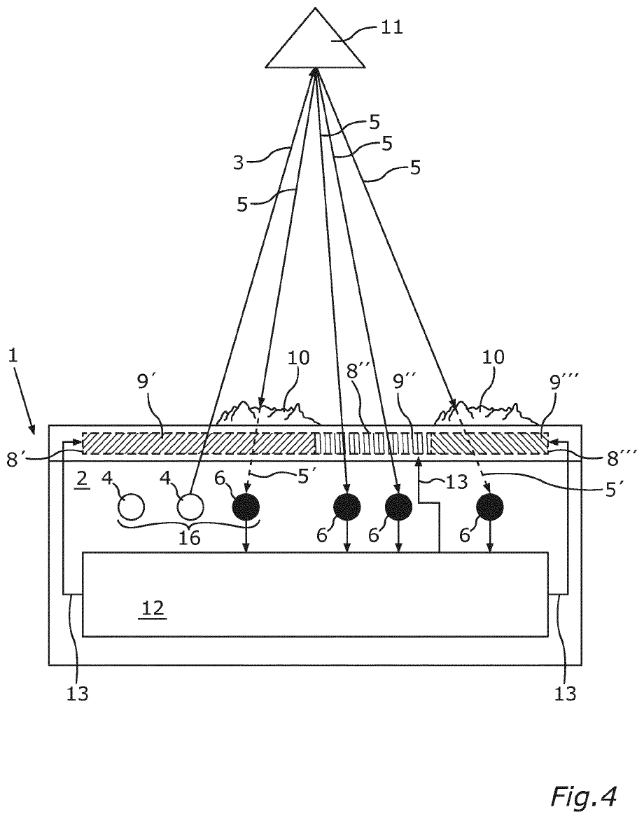

FIG. 4 shows a further exemplary embodiment of a temperature-controllable radar sensor system 1, wherein the at least one heating region 8 is formed by a first heating region 8′, a second heating region 8″ and a third heating region 8″'. Correspondingly, the temperature-controllable radar sensor system 1 has a first heating element 9′, a second heating element 9″ and a third heating element 9″' as the at least one heating element 9. In other words, the at least one heating element 9 is therefore formed by the first, the second and the third heating element.

The exemplary embodiment of FIG. 4 is intended to illustrate that it is also possible that one of the at least one transmission antenna 4 and also one of the at least two receiving antennas 6 can be assigned to one of the at least one heating region 8. For example, the subset of antennas 16 can be assigned to the first heating region 8′ of the at least one heating region 8. In the exemplary embodiment of FIG. 4, the subset of antennas 16 forms a subset of the set comprising the at least one transmission antenna 4 and the at least two receiving antennas 6. In other words, the subset of antennas 16 comprises both transmission antennas of the at least one transmission antenna 4 and one of the receiving antennas of the at least two receiving antennas 6.

1-10. (canceled)

11. A method for the early detection of precipitation deposits on a radome of a radar sensor of a vehicle and for the open-loop and/or closed-loop control of at least one heating element of the radome, the method comprising:
emitting a transmission signal by means of at least one transmission antenna of the radar sensor;
capturing a received signal by means of at least two receiving antennas of the radar sensor, wherein the received signal describes the transmission signal reflected by an object in the surroundings of the vehicle;
determining an attenuation parameter caused by precipitation deposits, wherein the attenuation parameter describes an attenuation of the received signal;
outputting a heating signal for the open-loop and/or closed-loop control of the at least one heating element of the radome, wherein the heating signal is output as a function of the attenuation parameter; and
detecting an early precipitation deposit in at least one heating region of the radome on the basis of the attenuation parameter, wherein the at least one heating region describes a subregion of the radome, wherein the at least one heating region of the radome is associated with a subset of antennas, and wherein the subset of antennas describes any subset of a set comprising the at least one transmission antenna and the at least two receiving antennas.

12. The method of claim 11, wherein the heating signal additionally describes the at least one heating region of the radome within which the early precipitation deposit is detected.

13. The method of claim 11,
wherein at least one receiving-antenna attenuation parameter is determined for one of the at least two receiving antennas when the attenuation parameter is determined, and
wherein the receiving-antenna attenuation parameter describes the attenuation at one of the at least two receiving antennas caused by precipitation deposits.

14. The method of claim 11,
wherein at least one transmission-antenna attenuation parameter is determined for one of the at least one transmission antenna when the attenuation parameter is determined, and
wherein the transmission-antenna attenuation parameter describes the attenuation at one of the at least one transmission antenna caused by precipitation deposits.

15. The method of claim 11, wherein the determination of the attenuation parameter comprises a radar target comparison in which antenna-specific radar target signals, which are determined for each of the at least two receiving antennas by means of the received signal and describe one object in the surroundings of the vehicle, are compared with one another.

16. The method of claim 15, wherein the radar target comparison comprises a comparison of the amplitude, phase and/or frequency of the antenna-specific radar target signals.

17. The method of claim 15,
wherein a temporal and/or spatial plausibility check is carried out in the radar target comparison,
wherein, in the temporal plausibility check, the radar target comparison is repeated during a further measurement cycle of the radar sensor and,
wherein, in the spatial plausibility check, the radar target comparison is repeated with at least one further antenna-specific radar target signal which describes a further object in the surroundings of the vehicle.

18. A non-transitory computer-readable medium storing instructions that, when executed by a computing device, configures the computing device to:
activate a radar sensor to emit a transmission signal by means of at least one transmission antenna of the radar sensor;
receive a received signal captured by means of at least two receiving antennas of the radar sensor, wherein the received signal describes the transmission signal reflected by an object in the surroundings of the vehicle;
determine an attenuation parameter that describes an attenuation of the received signal and is caused by precipitation deposits;
activate and/or closed-loop control the at least one heating element of the radome by means of a heating signal as a function of the attenuation parameter;
detect an early precipitation deposit in at least one heating region of the radome on the basis of the attenuation parameter, wherein the at least one heating region describes a subregion of the radome; and
associate the heating region of the radome with a subset of antennas, wherein the subset of antennas describes any subset of a set comprising the at least one transmission antenna and the at least two receiving antennas.

19. A temperature-controllable radar sensor system for a vehicle, comprising:
a radar sensor configured to emit a transmission signal by means of at least one transmission antenna and to capture a received signal by means of at least two receiving antennas;
a radome comprising at least one heating region, wherein the temperature of the radome can be controlled by means of at least one heating element, wherein the radome is arranged at least partially within a visual field of a subset of antennas, and wherein the subset of antennas describes any subset of a set comprising the at least one transmission antenna and the at least two receiving antennas;
at least one heating element which is designed to control the temperature of the at least one heating region of the radome as a result of a heating signal output by a computing device; and
a computing device configured to:
activate the radar sensor to emit the transmission signal by means of the at least one transmission antenna of the radar sensor,
receive the received signal captured by means of the at least two receiving antennas of the radar sensor, wherein the received signal describes the transmission signal reflected by an object in the surroundings of the vehicle,
determine an attenuation parameter that describes an attenuation of the received signal and is caused by precipitation deposits,
activate and/or closed-loop control the at least one heating element of the radome by means of a heating signal as a function of the attenuation parameter,
detect an early precipitation deposit in at least one heating region of the radome on the basis of the attenuation parameter, wherein the at least one heating region describes a subregion of the radome, and
associate the heating region of the radome with the subset of antennas.
